(19) United States
(12) Patent Application Publication
(10) Pub. No.: US 2026/0105684 A1
(43) Pub. Date: Apr. 16, 2026

(54) POINT CLOUD DATA PROCESSING METHOD, ELECTRONIC DEVICE, AND COMPUTER-READABLE STORAGE MEDIUM

(71) Applicant: UBTECH ROBOTICS CORP LTD, Shenzhen (CN)

(72) Inventors: JIAHAO JI, Shenzhen (CN); Jichao Jiao, Shenzhen (CN); Simin Zhang, Shenzhen (CN)

(21) Appl. No.: 19/231,618

(22) Filed: Jun. 9, 2025

(30) Foreign Application Priority Data
Oct. 11, 2024 (CN) 202411429502.6

(51) Int. Cl. G06T 17/00; B25J 9/16

(52) U.S. Cl. CPC G06T 17/00; B25J 9/1697; G06T 2200/04

(57) ABSTRACT

A point cloud data processing method, an electronic device, and a computer-readable storage medium are provided. The method includes: obtaining a plurality of obstacle point clouds, and extracting wall surface point cloud(s) from the plurality of obstacle point clouds; obtaining a first point cloud vector by projecting the obstacle point clouds in the plurality of obstacle point clouds other than the wall surface point cloud(s) to a ground surface; projecting the wall surface point cloud(s) to the ground surface, and obtaining a straight line by performing a linear fitting on the projected wall surface point cloud(s); obtaining a second point cloud vector by screening the projected wall surface point cloud(s) based on the straight line; and combining the first point cloud vector and the second point cloud vector into along-edge semantic information. Through present disclosure, more accurate along-edge semantic information can be obtained.

### CROSS REFERENCE TO RELATED APPLICATIONS

The present disclosure claims priority to Chinese Patent Application No. 202411429502.6, filed Oct. 11, 2024, which is hereby incorporated by reference herein a10s if set forth in its entirety.

### TECHNICAL FIELD

The present disclosure relates to data processing, and particularly to a point cloud data processing method, an electronic device, and a computer-readable storage medium.

### BACKGROUND SURFACE

Cleaning robots (e.g., sweeping robots) and some other types of robots have the need to strictly move along the edge (or wall). In related technologies, it usually uses point cloud irradiated on the wall by LiDAR as along-edge semantics to perform planning and control on the robot so as to move along the edge. However, due to the insufficient three-dimensional perception ability of the LiDAR, the obtained along-edge semantic information will have low accuracy.

### BRIEF DESCRIPTION OF DRAWINGS

FIG. 1 is a schematic diagram of the structure of a point cloud data processing system 100 according to an embodiment of the present disclosure.

FIG. 2 is a schematic diagram of the structure of an electronic device 500 according to an embodiment of the present disclosure.

FIG. 3 is a flow chart of a point cloud data processing method according to an embodiment of the present disclosure.

FIG. 4 is a flow chart of an example of step 102 in the point cloud data processing method of FIG. 3 according to an embodiment of the present disclosure.

FIG. 5 is a flow chart of an example of step 106 in the point cloud data processing method of FIG. 3 according to an embodiment of the present disclosure.

FIG. 6 is a schematic diagram of the process of the point cloud data processing method according to an embodiment of the present disclosure.

FIG. 7 is a schematic diagram of an efficiency of the point cloud data processing method according to an embodiment of the present disclosure.

FIG. 8 is a schematic diagram of another efficiency of the point cloud data processing method according to an embodiment of the present disclosure.

### DETAILED DESCRIPTION

In order to make the purpose, technical solutions and advantages of the present disclosure clearer, it will be further described in detail below in conjunction with the drawings. The described embodiments should not be regarded as limitations of the present disclosure, and all other embodiments obtained by those skilled in the art, under the premise of no creative labor, will fall within the scope of the protection of the present disclosure.

In the following descriptions, “some embodiments” are involved, which describe a subset of all possible embodiments. It should be noted that “some embodiments” may refer to the same subset or different subset of all possible embodiments, which can be combined with each other when there is no conflict.

In the embodiments of the present disclosure, the term “module” or “unit” refers to a computer program or part of a computer program with preset functions and works with other related parts to achieve predetermined goals and may be implemented by using software, hardware (e.g., processing circuit or storage) or a combination thereof in whole or in part. Likewise, a processor (or a plurality of processors or storages) may be used to implement one or more modules or units. In addition, each module or unit may be part of an integral module or unit containing the function of the module or unit.

In the following descriptions, the involved terms “first”, “second”, and the like are merely for differentiating similar objects and do not represent a specific order for the objects. It should be noted that the specific order or sequence of “first”, “second”, and the like may be interchanged under certain conditions so that the embodiments of the present disclosure described herein may be implemented in an order other than those illustrated or described herein.

Unless otherwise defined, all technical and scientific terms used in the embodiments of the present disclosure have the same meaning as commonly understood by those skilled in the art. The terms used in the embodiments of the present disclosure are merely for describing the embodiments of the present disclosure rather than limiting them.

Before further detailed description of the embodiments of the present disclosure, the involved nouns and terms will be described as follows.

1) “LiDAR” (Light Detection and Ranging) is a remote sensing technology used to measure distances, which determines the distance of the target by emitting laser pulses to the target and measuring the time difference or phase changes of reflected light waves. A LIDAR system usually include a laser emitter, a receiver (e.g., a photodiode or optical lens) and a processor. Common LiDARs include pulsed LiDAR, continuous wave LiDAR, multi-frequency LiDAR r, and the like. LiDARs are widely used in various fields such as autonomous driving, robot navigation, and security monitoring.

2) “[D]epth camera” is an imaging device that can detect three-dimensional information of an object. It may obtain the depth information of the scene through different technical means such as time of flight (TOF), structured light, and binocular stereo vision. Compared with LiDARs, depth cameras have higher three-dimensional perception capabilities.

3) “[A]long-edge semantic information” refers to the semantic labels or category information related to edges in images or point cloud data. This information is usually obtained through the edge detection algorithm and subsequent semantic segmentation technique.

4) “[O]utlier point cloud” refers to the points that are significantly different from other points in a point cloud data set. These points may be caused by measurement errors, anomalies during data collection, or actual objects in the scene. The detection and removal of outlier point clouds are important steps in point cloud processing. Outlier point clouds usually have the characteristics of long distances, low field density, and not following the overall trend.

Cleaning robots and some other types of robots will have the need to move strictly along the edge (or wall).

In related technologies, there are two main along-edge solutions. One solution is to use the point cloud irradiated on the wall by the LiDAR to use as along-edge semantics, thereby providing a basis for the robot to plan and control along-edge motions. However, this method has two issues. On the one hand, the LiDAR has low accuracy at close range that the measured distance will fluctuate, resulting in the along-edge semantics not straight and inaccurate. If the along-edge motions are too close to the wall, which is easy to cause the robot to hit the wall; otherwise, if the along-edge motions are too far to achieve strict along-edge, which causes difficulties for planning and control. On the other hand, cleaning type robots that require along-edge functions will generally be installed with only two-dimensional LiDAR, and can only perceive the along-edge semantic information at the installed height of the LiDAR. When there are obstacles at other heights, the robot may easily hit the obstacle. The other solution is that the relevant deployment personnel directly push the robot along the path to form a teaching path, which can generally avoid hitting the wall, while the deployment cost is high.

That is, due to the insufficient three-dimensional perception ability of the LiDAR, the related laser edge technologies prone to cause the robots to collision with obstacles that are at the heights cannot be perceived by the LiDAR. In addition, due to the point cloud fluctuations easily lead to the low accuracy of the obtained edge semantic information, which makes the robot's along-edge motions incoherent.

In view of this, the embodiments of present disclosure provide a point cloud data processing method, an apparatus, an electronic device, a computer-readable storage medium, which can obtain more accurate along-edge semantic information so that the robot has better obstacle avoidance ability. The electronic device provided by the embodiments of present disclosure may be implemented as a server, or be implemented as a coordinate server and terminal. In below, as an example for description, the point cloud data processing method provided by the embodiments of present disclosure is implemented by the coordinate server and terminal.

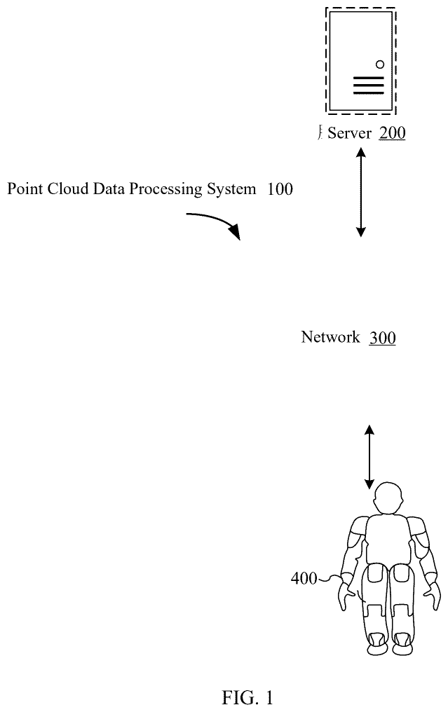

FIG. 1 is a schematic diagram of the structure of a point cloud data processing system 100 according to an embodiment of the present disclosure. As shown in FIG. 1, in order to support a point cloud data processing application, the point cloud data processing system 100 may include a server 200, a network 300, and a terminal 400 (e.g., a robot of various type). In which, the terminal 400 is connected to the server 200 through the network 300, and the network 300 may be a local area network, a wide area network, or a combination of the two.

In some embodiments, after obtaining a plurality of obstacle point clouds, the terminal 400 may transmit the plurality of obstacle point clouds to the server 200 through the network 300, and the server 200 may extract wall surface point cloud(s) from the plurality of obstacle point cloud. Then, the server 200 may obtain a first point cloud vector by projecting the obstacle point clouds in the plurality of obstacle point clouds other than the wall surface point cloud(s) to a ground surface, and project the wall surface point cloud(s) to the ground surface to obtain a straight line by performing a linear fitting on the projected wall surface point cloud(s). Furthermore, the server 200 may obtain a second point cloud vector by screening the projected wall surface point cloud(s) based on the straight line, and finally combine the first point cloud vector and the second point cloud vector into along-edge semantic information to return to the terminal 400 through the network 300, so that the terminal 400 can perform along-edge tasks based on the along-edge semantic information.

In some embodiments, the foregoing process may also be implemented individually by the terminal 400. For example, the terminal 400 may determine the along-edge semantic information based on its own computing capabilities and perform along-edge motion based on the along-edge semantic information.

It should be noted that the technical solutions provided by the embodiments of the present disclosure may be applied to various scenarios, for example, home cleaning, warehousing and logistics, lawn mowing, safety patrol, and other robot along-edge motion scenarios.

In some embodiments, taking a home cleaning robot in an along-edge scene as an example, first, the home cleaning robot obtains a plurality of obstacle point clouds, and extracts wall surface point cloud(s) from the plurality of obstacle point clouds; then obtains a first point cloud vector by projecting the obstacle point clouds in the plurality of obstacle point clouds other than the wall surface point cloud(s) to a ground surface; and then projects the wall surface point cloud(s) to the ground surface, and obtains a straight line by performing a linear fitting on the projected wall surface point cloud(s); furthermore, obtains a second point cloud vector by screening the projected wall surface point cloud(s) based on the straight line; and finally combines the first point cloud vector and the second point cloud vector into the along-edge semantic information so as to control the home cleaning robot to perform along-edge motions according to the along-edge semantic information, thereby achieving the home cleaning work.

In some embodiments, taking a lawn mowing robot in an along-edge motion scene as an example, first, the lawn mowing robot obtains a plurality of three-dimensional point clouds by scanning obstacles at lawn edge using a depth camera; then selects the three-dimensional point clouds with the height larger than a height threshold from the plurality of three-dimensional point clouds to use as a plurality of obstacle point clouds; and then obtains a first point cloud vector by projecting the obstacle point clouds in the plurality of obstacle point clouds other than the wall surface point cloud(s) to a ground surface; and then projects the wall surface point cloud(s) to the ground surface, and obtains a straight line by performing a linear fitting on the projected wall surface point cloud(s); furthermore, obtains a second point cloud vector by screening the projected wall surface point cloud(s) based on the straight line; and finally combines the first point cloud vector and the second point cloud vector into the along-edge semantic information so as to control the lawn mowing robot to perform along-edge motions based on the along-edge semantic information, thereby achieving the lawn mowing work.

In other embodiments, the embodiments of the present disclosure may also be implemented with the help of cloud technology, which refers to a hosting technology that unifies hardware, software, network and other resources in a wide area network or local area network to realize data calculation, storage, processing, and sharing.

Cloud technology is a general term for cloud computing business model application-based network technology, information technology, integration technology, management platform technology, and application technology, which may form a resource pool that can be used as needed and in a flexible and convenient manner. Cloud technology will become an important support, since the backend service of the technical network system requires a large amount of computing and storage resources.

For example, the server 200 in FIG. 1 may be a stand-alone physical server, or a server cluster or distributed system composed of multiple physical servers, or may also be a cloud server providing cloud service, cloud database, cloud computing, cloud function, cloud storage, network service, cloud communication, middleware service, domain name service, security service, content delivery network (CDN), and basic cloud computing service such as big data and artificial intelligence platform. The terminal 400 may be a smartphone, tablet computer, laptop computer, desktop computer, smart speaker, smart watch, car terminal, and various types of robots (e.g., sweeping robot or weeding robot). The terminal 400 and the server 200 may be directly or indirectly connected through wired or wireless communication methods.

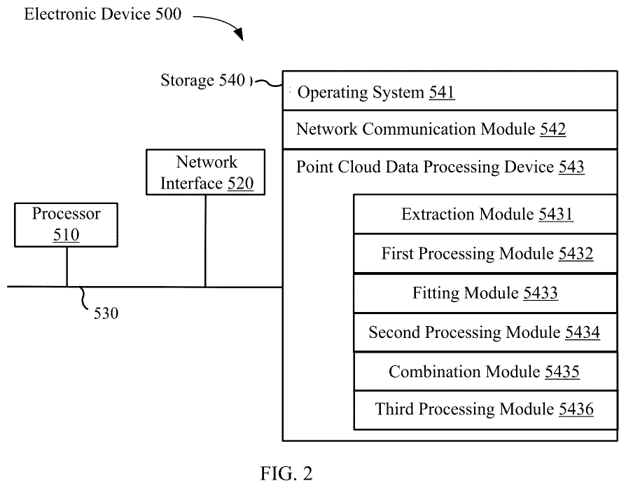

The structure of the electronic device provided by the embodiments of the present disclosure will continue to be described as follows. FIG. 2 is a schematic diagram of the structure of the electronic device 500 according to an embodiment of the present disclosure. As shown in FIG. 2, the electronic device 500 may include at least one processor 510, a storage 540, and at least one network interface 520, where these various components of the electronic device 500 are coupled together through a bus system 530. It can be understood that the bus system 530t is for realizing connection communication between these components. The bus system 530 may include, in addition to a data bus, a power bus, a control bus, and a status signal bus. Though, for clarity, the various buses are merely marked as the bus system 530 in FIG. 2.

The processor 510 may be an integrated circuit chip with signal processing capabilities, which may be, for example, a general-purpose processor, a digital signal processor (DSP), or other programmable logic device, discrete gate or transistor logic device, discrete hardware component, or the like. In which, the general-purpose processor may be a microprocessor, any conventional processor, or the like.

The storage 540 may be removable, non-removable, or a combination thereof. For example, the storage 540 hardware device may include solid state memory, hard disk drive, optical disk drive, or the like. The storage 540 may optionally include one or more storage devices physically located away from the processor 510.

The storage 540 may include volatile memory, nonvolatile memory, or both. The nonvolatile memory may be read-only memory (ROM), and the volatile memory may be random access memory (RAM). In this embodiment, the storage 540 is intended to include any suitable type of storages.

In some embodiments, the storage 540 is able to store data to support various operations. The data may include, for example, programs, modules, data structures, or subsets or supersets thereof, as described below.

An operating system 541 includes system programs for processing various basic system services and performing hardware-related tasks, such as framework layer, core library layer, and driver layer that are for realizing various basic services and processing hardware-based tasks.

A network communication module 542 is configured to reach other electronic devices via the one or more (wired or wireless) network interfaces 520. For example, the network interface 520 may include Bluetooth, wireless compatibility authentication (Wi-Fi), universal serial bus (USB), and the like.

In some embodiments, the apparatus provided by the embodiments of the present disclosure may be implemented in software. As shown in FIG. 2, there is a point cloud data processing device 543 stored in the storage 540, which may be a software in the form of program, plug-in, or the like that may include software modules namely an extraction module 5431, a first processing module 5432, a fitting module 5433, a second processing module 5434, a combination module 5435, and a third processing module 5436. These modules are logical, so any combination or further disassembly may be performed according to the functions to be implemented. It should be noted that in FIG. 2, for the convenience of expression, all the foregoing modules are shown at once, but it should not be regarded as excluding the implementation of the point cloud data processing device 543 that may only include the extraction module 5431, the first processing module 5432, the fitting module 5433, the second processing module 5434 and the combination module 5435. The functions of each module will be described below.

The point cloud data processing method provided by the embodiments of present disclosure will be described in detail below in light of the exemplary application and implementation of the server 200 provided by the embodiments of present disclosure.

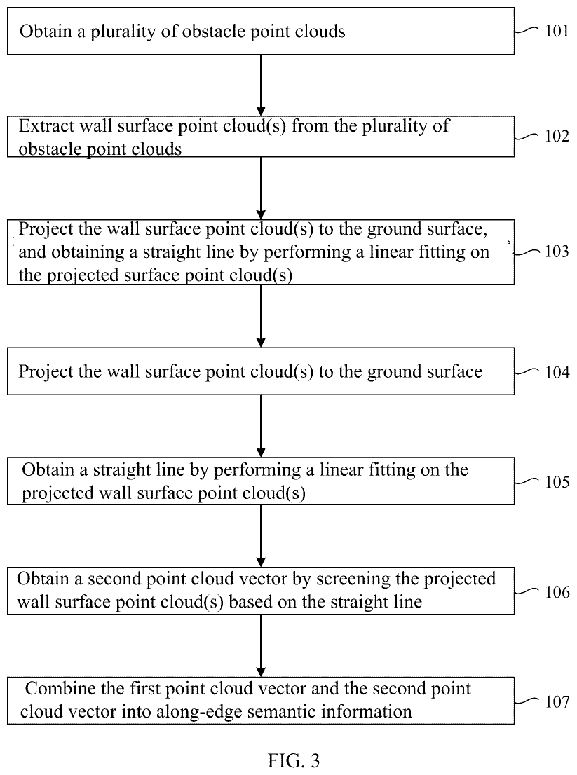

FIG. 3 is a flow chart of a point cloud data processing method according to an embodiment of the present disclosure. As shown in FIG. 3, in this embodiment, the point cloud data processing method provided by the embodiment of present disclosure will be explained in conjunction with the steps.

Step 101: obtaining a plurality of obstacle point clouds.

In some embodiments, sensors such as LiDAR, camera, depth camera or radar may be used to directly scan the obstacle to obtain spatial point cloud data of obstacles.

For example, assuming that a LiDAR is installed on the operating platform of a robot, the robot may scan obstacles through the LiDAR to capture the spatial point cloud data of obstacles, thereby processing the obtained spatial point cloud data to help the robot to realize obstacle avoidance operations. Assumed to install a radar on a car, the car may obtain the spatial point cloud data of obstacles through the radar, thereby processing the obtained spatial point cloud data to realize intelligent obstacle avoidance operations during autonomous driving.

In some embodiments, the above-mentioned step 101 may include: obtaining a plurality of three-dimensional point cloud by scanning a wall using a depth camera; and selecting the three-dimensional point clouds with a height larger than a height threshold from the plurality of three-dimensional point cloud to use as the plurality of obstacle point clouds.

It should be noted that the depth camera may be a built-in camera of the robot itself, or an external camera that is later connected as needed.

In some embodiments, it may use the depth camera (e.g., Kinect or Intel RealSense) to scan the wall to capture depth information of the environment of the current scene and obtain three-dimensional point cloud data, then obtain three-dimensional spatial coordinates (i.e., the coordinates of the point cloud that correspond to the x-axis, y-axis and z-axis in a spatial Cartesian coordinate system) of each point cloud, and then screen, based on height information (i.e., z-axis coordinate) of the point cloud, three-dimensional point cloud with the height information larger than a height threshold (e.g., the threshold of 0 is to use the point cloud higher than the ground surface as the obstacle point cloud) to obtain the obstacle point cloud.

In which, the height threshold may be set manually by the user, or may be obtained by dynamic analysis based on the height information of obstacles obtained through the depth camera or other sensor.

For example, regarding the home cleaning robot, it may first scan the wall through the installed depth camera to capture depth information of the environment of the current scene and obtain three-dimensional point cloud data, and obtains three-dimensional spatial coordinates of each point cloud to generates a point cloud data set containing multiple three-dimensional coordinate points, then determine the height threshold of 100 pixels based on the height of the obstacle point cloud, that is, consider the point cloud with the z-axis coordinate larger than 100 pixels as the obstacle point cloud, and then screen the point cloud data set according to the height threshold so as to screen out only the point clouds with the z-axis coordinate height larger than 100 pixels, that is, obtain the corresponding obstacle point cloud.

In some embodiments, the above-mentioned selecting the three-dimensional point clouds with the height larger than the height threshold from the plurality of three-dimensional point cloud to use as the plurality of obstacle point clouds may include: determining, based on a relative positional relationship between an edge of the wall and the robot, an along-edge strategy for a robot; selecting the three-dimensional point clouds with the height larger than the height threshold and located on the right side of the depth camera to use as the plurality of obstacle point clouds in response to the along-edge strategy being along right edge; and selecting the three-dimensional point clouds with the height larger than the height threshold and located on the left side of the depth camera to use as the plurality of obstacle point clouds in response to the along-edge strategy being along left edge.

In some embodiments, the relative position between the edge of the wall and the robot may be obtained through sensors. If the distance between the left side of the robot and the edge of the wall is larger than that between the right side of the robot and the edge of the wall, it may be determined to adopt the along-right-edge strategy (i.e., to control the robot to move with its right side along the edge of the wall); otherwise, if the distance between the right side of the robot and the edge of the wall is larger than that between the left side of the robot and the edge of the wall, it may be determined to adopt the along-left-edge strategy (i.e., to control the robot to move with its left side along the edge of the wall). When the along-edge strategy is the along-right-edge strategy, the point clouds with the y-axis coordinate larger than 0 in the three-dimensional coordinates of the obstacle point clouds may be saved to obtain the corresponding obstacle point clouds; otherwise, when the along-edge strategy is the along-left-edge strategy, the point clouds with the y-axis coordinate less than 0 and the z-axis coordinate larger than the height threshold in the three-dimensional coordinates of the obstacle point cloud may be saved to obtain the corresponding obstacle point clouds.

For example, taking the home cleaning robot as an example, suppose that the distance between the edge of the wall and the left side of the robot that is obtained through the depth camera sensor is 100 pixels, and that between the edge of the wall and the right side of the robot is 300 pixels, it may be determined through comparison that the robot needs to adopt the along-left-edge strategy, and screen out the point clouds with the y-axis coordinates with less than 0 and the z-axis coordinates larger than the height threshold (e.g., 100 pixels) from the point cloud data set, that is, obtain the corresponding obstacle point clouds.

In some embodiments, when the number of the plurality of obstacle point clouds is less than a quantity threshold, it may rescan the wall using the depth camera to obtain the three-dimensional point clouds in response to a number of the plurality of obstacle point clouds being less than a quantity threshold; and extract the obstacle point clouds from the three-dimensional point clouds obtained by rescanning the wall.

In which, the quantity threshold may be set manually by the user, or may be dynamically set by the robot according to the scene conditions.

For example, assuming that the number of the plurality of obstacle point clouds obtained by the robot for the first time is 50, less than the quantity threshold of 100, it may control the depth camera of the robot to adjust the angle and scan the wall again to obtain the point clouds for the area that has not been scanned before so as to obtain the three-dimensional point cloud after re-scanning, then screen the re-scanned three-dimensional point cloud to obtain the corresponding obstacle point clouds.

In some embodiments, when the number of the plurality of obstacle point clouds is less than the quantity threshold, it may control the robot to use the installed LiDAR device to scan the wall to obtain the three-dimensional point cloud data of the current scene, then preprocess (e.g., denoising, filtering, and removing abnormal points) the collected point cloud data to improve the quality of the point cloud, and then use machine learning or deep learning methods to classify the point cloud data to determine a wall point cloud. Subsequently, it may detect the edge or contour of the wall by using the edge detection algorithm (e.g., Canny operator, or calculating the curvature of points in the point clouds to identify edge points) upon the wall point cloud to obtain a wall edge point cloud, then convert the data of the wall edge point cloud into the coordinate system of the robot to ensure that the robot can understand and utilize the data of the wall edge point cloud. Finally, it may generate the along-edge semantic information based on the wall edge point cloud, so as to make the control system to plan the robot's walking path and motion strategy based on the along-edge semantic information.

For example, suppose there is a robot walking along the wall in an indoor environment, and the number of the obstacle point clouds obtained by the robot through scanning using the depth camera is 70, less than the quantity threshold of 100. The robot controls the LiDAR of itself to scan the wall and collect the three-dimensional point cloud data of the current scene, and the computer system inside the robot preprocesses the collected point cloud data and removes the abnormal point clouds caused by environmental interference or equipment errors. Then, a machine learning algorithm is used to classify the point cloud data to determine the wall point cloud, and the robot further analyzes the wall point cloud to detect the edge of the wall and obtain the edge point cloud of the wall, and then the robot converts the coordinate system of the LiDAR into the coordinate system of the robot itself. Finally, the robot generates the along-edge semantic information based on the edge point cloud of the wall, and determines the path for the robot to walk along the wall and the strategy of walking along the wall based on the along-edge semantic information.

Step 102: extracting wall surface point cloud(s) from the plurality of obstacle point clouds.

It should be noted that it may use the point cloud segmentation algorithm to divide the wall surface point cloud(s) from the plurality of obstacle point clouds, the clustering algorithms to screen out the wall surface point cloud(s) from the plurality of obstacle point clouds, or the machine learning or deep learning algorithms to classify the obstacle point clouds to obtain the wall surface point cloud(s).

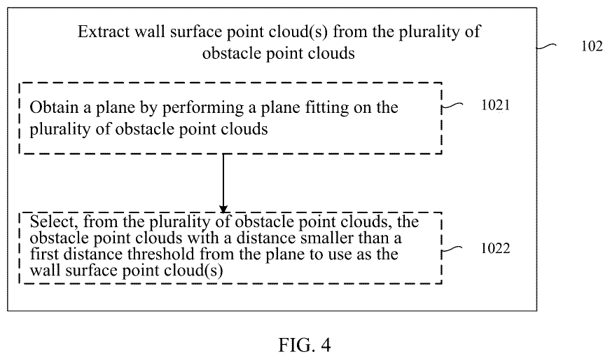

FIG. 4 is a flow chart of an example of step 102 in the point cloud data processing method of FIG. 3 according to an embodiment of the present disclosure. As shown in FIG. 4, step 102 shown in FIG. 3 may include steps 1021-1022 that are shown in FIG. 4, which will be described in conjunction with the steps shown in FIG. 4.

Step 1021: obtaining a plane by performing a plane fitting on the plurality of obstacle point clouds.

In some embodiments, the above-mentioned obtaining the plane by performing the plane fitting on the plurality of obstacle point clouds of step 1021 may include: selecting a part of point clouds from the plurality of obstacle point clouds; building a fitted plane equation (e.g., Ax+By+Cz+D=0) based on the selected part of point clouds; calculating the distance between other obstacle point clouds except the selected part of point clouds and the fitted plane to determine an error of the fitted plane; and selecting different point clouds from the obstacle point clouds to perform plane fitting or adjusting parameters of the fitted plane equation in response to the error exceeding an error range.

It should be noted that the way to select the part of point clouds from the plurality of obstacle point clouds may be randomly selected or selected according to certain standards (e.g., the uniformity of points distribution).

For example, suppose there is a set of obstacle point cloud data {(x₁,y₁,z₁), (x₂,y₂,z₂), . . . , (xₙ,yₙ,zₙ)}, and it randomly selects m point cloud data from a total of n sets of obstacle point cloud data, where m is a positive integer less than n. It builds the fitting plane equation Ax+By+Cz+D=0 based on the selected m point cloud data, calculates the distance between the n-m remaining obstacle point clouds and the fitting plane, and determines the error of the fitting plane. If the error exceeds the error range, it selects different point clouds from the obstacle point clouds for plane fitting, or adjusts the parameters of the fitting plane equation.

In some embodiments, the above-mentioned obtaining the plane by performing the plane fitting on the plurality of obstacle point cloud of step 1021 may include: setting a maximum number of iterations, an inner point threshold, and an inner point quantity threshold; randomly selecting a minimum number (e.g., 3) of point cloud fitting planes from the plurality of obstacle point clouds; calculating model parameters of the fitting plane using the selected point cloud data; calculating the distance between the obstacle point clouds other than the randomly selected point clouds and the fitting plane, and marking the point clouds with the distance less than the inner point threshold as inner points; determining the number of the inner points, and determining the current model as the best model in response to the number of the inner points being larger than the inner point quantity threshold; and iterating continuously until the maximum number of iterations is reached, and selecting the plane with the most inner points as the best plane model.

For example, suppose there is a set of obstacle point cloud data, and it sets the maximum number of iterations to 100 times, the inner point threshold to 10 pixels, and the inner point quantity threshold to 30 points. In each iteration, it randomly selects three points to fit a plane. For each fitted plane, it calculates the distance between all points and the plane, marks the points with the distance of less than 10 pixels as the inner points, and checks the number of the inner points. If there are more than 30 inner points and the model quality is better than the previous model, it updates the best model (i.e., replace the previous model by the current model), and iterates continuously until the maximum number of iterations reaches 100 times, and selects the plane with the most inner points as the best plane model after all iterations are completed.

In some embodiments, the above-mentioned obtaining the plane by performing the plane fitting on the plurality of obstacle point cloud of step 1021 may include: calculating a covariance matrix corresponding to the plurality of obstacle point clouds; determining the first N principal components in the covariance matrix, where the principal components represent the main variance direction of the obstacle point cloud, and N is a positive integer larger than 0; and building the plane equation based on the first N principal components to obtain the fitted plane.

It should be noted that in the process of determining the first N principal components in the covariance matrix, the value of N may be set manually by the user, or the principal components that are larger than a contribution rate threshold may be dynamically screened according to the contribution rate of the set principal components, and no specific limitations are given here.

For example, suppose there is a set of obstacle point cloud data, it calculates a covariance matrix corresponding to the obstacle point cloud, and performs eigenvalue decomposition on the covariance matrix to obtain the corresponding eigenvalue and eigenvector. In which, the volume of the eigenvalue represents that of the variance of the data distribution in each direction, and the eigenvector represents these directions. It screens out the first N eigenvectors with larger eigenvalues that have the corresponding directions of the main variation direction of the data, that is, the normal vector of the plane, and builds the fitting plane equation based on the first N eigenvectors to calculate the distance between all the obstacle point clouds and the fitting plane for evaluating the quality of the fitting. The fitting plane equation may be improved by adjusting the parameters, and finally the corresponding fitting plane may be determined.

Sep 1022: selecting, from the plurality of obstacle point clouds, the obstacle point clouds with a distance smaller than a first distance threshold from the plane to use as the wall surface point cloud(s).

In some embodiments, it may calculate the distance between each obstacle point cloud and the plane, set a first distance threshold, and screen out the obstacle point cloud with the distance smaller than the first distance threshold to use as the wall surface point cloud.

It should be noted that the first distance threshold may be a preset value or be set dynamically according to the needs of different application scenes.

For example, suppose there is an obstacle point cloud P(x₀, y₀, z₀), and the fitting plane equation is Ax+By+Cz+D=0, the distance d between the obstacle point cloud P and the fitting plane may be calculated using equation (1): assuming that the first distance threshold is d₀, if d is less than do, the obstacle point cloud P is used as the wall surface point cloud.

$$d = \frac{\vert A {x}_{0} + B {y}_{0} + C {z}_{0} + D \vert}{\sqrt{{A}^{2} + {B}^{2} + {C}^{2}}} \qquad ( 1 )$$

Sep 103, projecting the wall surface point cloud(s) to the ground surface, and obtaining a straight line by performing a linear fitting on the projected surface point cloud(s).

In some embodiments, when the plane corresponding to the ground surface is perpendicular to any coordinate axis in the spatial coordinate system, the point cloud coordinates after projecting the point clouds may be obtained by changing the coordinate values of the point clouds in the spatial coordinate system, thereby obtaining the first point cloud vector.

For example, assuming that the plane corresponding to the ground surface is perpendicular to the z-axis in the spatial coordinate system, the plane equation corresponding to the ground surface is z=z₃, and there is an obstacle point cloud Q (x₄, y₄, z₄) other than the wall surface point cloud, then the point cloud coordinate Qo after projecting the obstacle point cloud Q to the ground surface is (x₄, y₄, z₄), and all the projected point clouds are merged into a point cloud data set to obtain the first point cloud vector.

In some embodiments, the above-mentioned step 103 may include, for each obstacle point cloud in the plurality of obstacle point clouds other than the wall surface point cloud(s): determining a distance between each of the obstacle point clouds and the ground surface; determining, based on the distance and a normal vector of the ground surface, a projection point of each of the obstacle point clouds on the ground surface; and obtaining a first point cloud vector by combining the projection points of the obstacle point clouds.

In some embodiments, it may determine a distance between each of the obstacle point clouds and the ground surface through equation (1), and calculate the normal vector corresponding to the ground surface based on a ground surface equation; then determine the corresponding projection points of the obstacle point clouds on the ground surface based on the distance of the obstacle point cloud to the ground surface and the corresponding normal vector of the ground surface; and finally combine the projection points to obtain the first point cloud vector.

For example, suppose there is an obstacle point cloud L (x₅, y₅, z₅), and the plane equation corresponding to the ground surface is Ax+By+Cz+D=0. The distance d₁ of the obstacle point cloud to the ground surface may be calculated through equation (1), and the normal vector n of the plane equation corresponding to the ground surface is (A, B, C).

Then, the equation of the perpendicular line on point cloud L to the plane equation corresponding to the ground surface is calculated as

$$\frac{x - {x}_{5}}{A} = \frac{y - {y}_{5}}{B} = \frac{z - {z}_{5}}{C} .$$

Finally, based on distance d₁, the plane equation corresponding to the ground surface Ax+By+Cz+D=0, and the perpendicular line equation

$$\frac{x - {x}_{5}}{A} = \frac{y - {y}_{5}}{B} = \frac{z - {z}_{5}}{C} ,$$

the corresponding projection point L₀ of the obstacle point cloud on the plane of the ground surface is determined, and the projection points of all the obstacle point clouds are combined to obtain the first point cloud vector.

Sep 104: projecting the wall surface point cloud(s) to the ground surface.

It should be noted that in this embodiment, the implementation of step 104 is similar to that of step 103, which may be referenced to the implementation of step 103.

Sep 105, obtaining a straight line by performing a linear fitting on the projected wall surface point cloud(s).

It should be noted that after obtaining the projected wall surface point clouds, since the projected wall surface point clouds are all located on the same two-dimensional plane, a two-dimensional coordinate system may be established for the projected wall surface point clouds, that is, the three-dimensional point clouds will be reduced to two-dimensional, with only x-coordinate and y-coordinate.

In some embodiments, it may select an appropriate linear fitting method to perform linear fitting on the two-dimensional wall surface point cloud data, thereby obtaining the corresponding fitted straight line.

For example, regarding the least squares method, assume that there is the two-dimensional wall surface point cloud data {(x₁,y₁), (x₂,y₂), . . . , (xₙ,yₙ)}, it first calculates the mean of all the x coordinate and the y coordinate,

$$\overline{x} = \frac{{x}_{1} + {x}_{2} + … + {x}_{n}}{n} , and \\ \overline{y} = \frac{{y}_{1} + {y}_{2} + … + {y}_{n}}{n} ,$$

then calculates slope a of the fitted straight line through an equation of

$$\frac{Σ ( {y}_{i} - \overline{y} ) ( {x}_{i} - \overline{x} )}{{Σ ( {y}_{ι} - \overline{y} )}^{2}} ,$$

and then substitutes the mean coordinates and slope a of x and y into fitted straight line y=ax+b to obtain fitted straight line intercept b, that is, obtains the corresponding fitted straight line.

For example, regarding the Random Sample Consensus (RANSAC) algorithm, assume that there is the two-dimensional wall surface point cloud data {(x₁,y₁), (x₂,y₂), . . . , (xₙ,yₙ)}, it first sets the number of iterations k=1000, the minimum number of internal points d=2, and the distance threshold t=10 pixels, then performs the following iteration process: randomly select two points (x₁,y₁) and (x₂,y₂), calculate the slope

$$a = \frac{{y}_{2} - {y}_{1}}{{x}_{2} - {x}_{1}}$$

and the intercept b=y₁−a*x₁ based on the two points, calculate the distance between all the point clouds and the straight line, and mark the point clouds with the distance smaller than the distance threshold t as the inner points to count the number of inner points. If the number of the inner points is larger than that of points in the current best model and is larger than the minimum number of inner points d, the best model and the inner point set is updated. This iterative process is continuously performed until the number of iterations reaches k. Finally, the model with the largest number of the inner points is selected as the final fitted straight line.

Sep 106, obtaining a second point cloud vector by screening the projected wall surface point cloud(s) based on the straight line.

It should be noted that the first point cloud vector and the second point cloud vector are only for distinguishing point cloud vectors that save different data. The saved data in the two point cloud vectors may be the same or different.

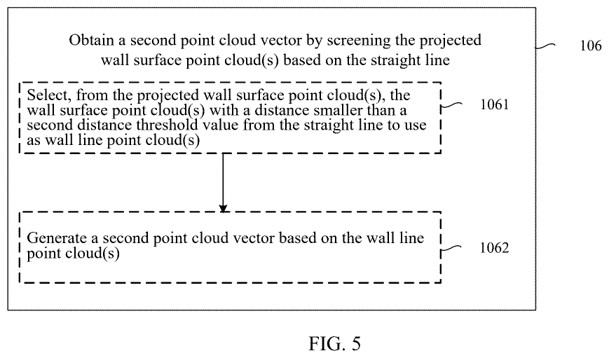

FIG. 5 is a flow chart of an example of step 106 in the point cloud data processing method of FIG. 3 according to an embodiment of the present disclosure. As shown in FIG. 5, step 106 in FIG. 3 may be implemented through steps 1061-1062 that are shown in FIG. 5, which will be described in conjunction with the steps shown in FIG. 5.

Sep 1061: selecting, from the projected wall surface point cloud(s), the wall surface point cloud(s) with a distance smaller than a second distance threshold value from the straight line to use as wall line point cloud(s).

In some embodiments, it may calculate the distance between each projected wall surface point cloud and the straight line, set the second distance threshold, and screen out the wall surface point cloud with the distance smaller than the second distance threshold as the wall line point cloud.

It should be noted that the first distance threshold and the second distance threshold are for distinguishing different distance thresholds, which may be the same or different. The second distance threshold may be a preset value, or may be set according to the needs of different application scenes.

For example, assuming that there is a projected wall surface point cloud M (x₀, y₀), and the equation for the fitted straight line is Ax+By+C=0, then distance d₂ between the projected wall surface point cloud M and the fitted straight line may be calculated using equation (2). Assuming that the second distance threshold is d₁, when d₂ is less than d₁, the projected wall surface point cloud is used as the wall line point cloud.

$${d}_{2} = \frac{\vert A {x}_{0} + B {y}_{0} + C \vert}{\sqrt{{A}^{2} + {B}^{2}}} \qquad ( 2 )$$

Sep 1062, generating a second point cloud vector based on the wall line point cloud(s).

In some embodiments, the foregoing step 1062 may include: identifying outlier point cloud(s) from the wall line point cloud(s); and deleting the outlier point cloud(s) from the wall line point cloud(s) to obtain remained wall line point clouds, and combining the remained wall line point cloud(s) into a second point cloud vector.

For example, assuming that there is a set of wall line point cloud data {(1,2,0), (1.1,2.1,0), (1.2,2.2,0), (1.3,2.3,0), (10,10,0), (1.4,2.4,0), (1.5,2.5,0)}. In which, most point clouds are closely clustered together, while point cloud (10,10,0) is obviously far away from the other point clouds, which may be a measurement error or outlier point cloud. It may calculate the average distance from each point cloud to the fitted straight line, then take those point clouds with the distances exceed the set threshold as the outlier point clouds. Assuming that the set threshold is 0.2, according to this threshold, the point cloud (10,10,0) is identified as the outlier point cloud, and the outlier point cloud is deleted to obtain the remained point cloud data: {(1,2,0), (1.1,2.1,0), (1.2,2.2,0), (1.3,2.3,0), (1.4,2.4,0), (1.5,2.5,0)}. Finally, the remained point cloud data is combined to obtain the second point cloud vector.

Sep 107, combining the first point cloud vector and the second point cloud vector into along-edge semantic information.

In some embodiments, it may combine the point cloud data in the first point cloud vector with that in the second point cloud vector to obtain the along-edge semantic information containing the point cloud data in the both point cloud vectors, and perform further processing (e.g., three-dimensional modeling, path planning, or obstacle detection) based on the along-edge semantic information.

For example, assuming that the first point cloud vector contains the obstacle point clouds other than the wall surface point clouds, and the second point cloud vector contains the screened wall line point clouds, it combines the two vectors and assigns each point with a semantic label to create the along-edge semantic information, that is, the combined along-edge semantic information. In which, each point cloud vector in the along-edge semantic information clearly identifies the type of the point cloud (i.e., the wall line point cloud or the obstacle point clouds other than the wall surface point cloud). Subsequently, the along-edge semantic information may be further processed (e.g., three-dimensional modeling, navigation path planning, or obstacle detection) to achieve precise control of the motion of the robot.

In below, an exemplary application of the embodiments of the present disclosure in an actual application scenario will be described. This exemplary application describes a specific implementation process of the point cloud data processing method in a robot along-edge motion scenario.

LiDAR along-edge technology is prone to collisions with obstacles that are not at its installation height due to its lack of three-dimensional perception, and the obtained along-edge semantic information is not straight due to the low accuracy of point clouds, resulting in the robot's along-edge motions incoherent. Compared with LiDAR, the three-dimensional point cloud of the depth camera has higher perception accuracy at close range and can perceive obstacles of different heights, thereby obtaining more comprehensive along-edge semantic information.

The present disclosure, by performing plane segmentation on obstacle point clouds using a typical plane segmentation algorithm to segment the wall surface point cloud and the protruding obstacle point clouds, projecting the wall surface point cloud to the ground surface for fitting to obtain the fitted straight line, retaining the point cloud data within a certain distance of the fitted straight line, and combining the point cloud data within a certain distance of the fitted straight line and the protruding obstacle point clouds to obtain the along-edge semantic information, the protruding obstacle point clouds are retained in the along-edge semantic information, thereby achieving better mechanical obstacle avoidance.

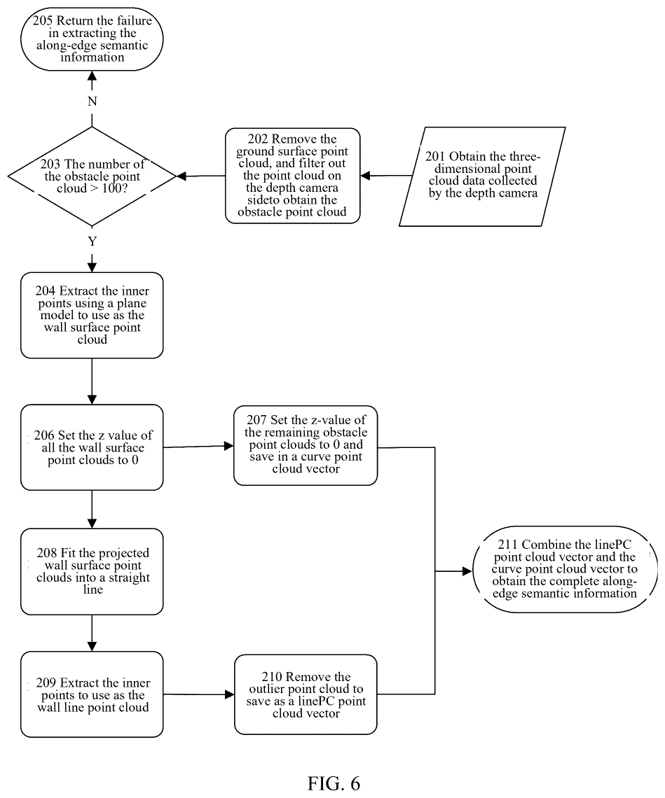

FIG. 6 is a schematic diagram of the process of the point cloud data processing method according to an embodiment of the present disclosure. As shown in FIG. 6, in this embodiment, the point cloud data processing method will be described below in conjunction with the specific process of FIG. 6.

Sep 201: obtaining the three-dimensional point cloud data collected by the depth camera.

For example, it uses the depth camera to scan the wall so as to capture the depth information of the environment of the current scene, thereby obtaining a plurality of three-dimensional point cloud data.

Sep 202: removing the ground surface point cloud, and filtering out the point cloud on the depth camera side according to the along-edge strategy to obtain the obstacle point cloud.

For example, first, it saves the point clouds with the height larger than the height threshold (i.e. the z-coordinate of the point cloud pointcloud.z>Z₀), then the relative position of the edge of the wall and the robot is obtained through the sensor. If the distance between the left side of the robot and the edge of the wall is larger than that between the right side of the robot and the edge of the wall, it determines to adopt the along-right-edge strategy to save the point clouds with the y-axis coordinate larger than 0 in the three-dimensional coordinates of the obstacle point cloud to obtain the corresponding obstacle point cloud; otherwise, if the distance between the left side of the robot and the edge of the wall is less than that between the right side of the robot and the edge of the wall, it determines to adopt the along-left-edge strategy to save the point clouds with the y-axis coordinate less than 0 in the three-dimensional coordinates of the obstacle point cloud to obtain the corresponding obstacle point cloud.

Step 203: determining whether the number of the obstacle point cloud is larger than 100, if yes, it performs step 204; otherwise, it performs step 205.

For example, if the number of the obstacle point clouds is larger than 100, it performs step 204; otherwise, if the number of obstacle point clouds is less than 100, it means that the number of the obstacle point cloud is too small to form a long enough along-edge semantic information, then the step 205 is performed.

Sep 204: extracting the inner points using a plane model to use as the wall surface point cloud.

For example, it uses the SACMODEL_PLANE model to perform plane fitting using the RANSAC algorithm so as to obtain the fitting plane, and uses the SACSegmentation method using opencv to extract the inner points to use as the wall surface point cloud.

Sep 205: returning the failure in extracting the along-edge semantic information.

For example, if the number of the obstacle point clouds is less than 100, it may return the prompt information of the failure of the current point cloud data processing method to extract the along-edge semantic information.

Sep 206: setting the z value of all the wall surface point clouds to 0.

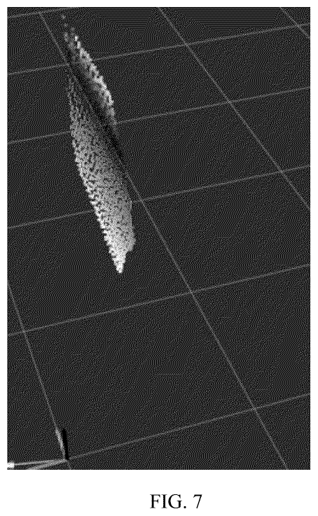

FIG. 7 is a schematic diagram of an efficiency of the point cloud data processing method according to an embodiment of the present disclosure. As shown in FIG. 7, all the wall surface point clouds are projected to the ground surface to obtain the projected wall surface point cloud.

Sep 207: setting the z-value of the remaining obstacle point clouds to 0 and saving in a curve point cloud vector.

In which, it may use curve point cloud vector to save other obstacle point cloud information other than the wall surface point cloud, thereby effectively realizing the robot's intelligent obstacle avoidance.

Sep 208: fitting the projected wall surface point clouds into a straight line.

For example, it may use the SACMODEL_LINE model to perform linear fitting using the RANSAC algorithm, thereby obtaining the fitted straight line.

Sep 209: extracting the inner points to use as the wall line point cloud.

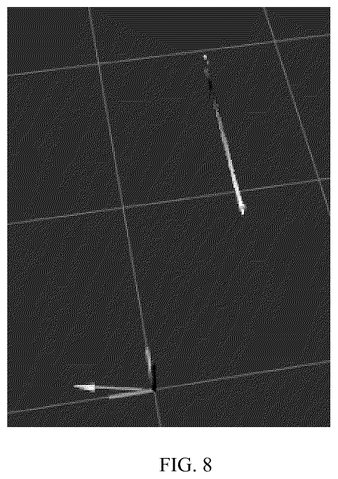

FIG. 8 is a schematic diagram of another efficiency of the point cloud data processing method according to an embodiment of the present disclosure. As shown in FIG. 8, it may use the SACSegmentation method of opencv to extract the inner points to take as the wall line point cloud, thereby achieving the shown effect.

Sep 210: removing the outlier point cloud to save as a linePC point cloud vector.

For example, it may use the RadiusOutlierRemoval method of opencv to remove outlier points, and save the result as a linePC point cloud vector.

Sep 211: combining the linePC point cloud vector and the curve point cloud vector to obtain the complete along-edge semantic information.

For example, it may merge the two point cloud vectors to obtain the final along-edge semantic information, so as to further process (e.g., three-dimensional modeling, navigation path planning, or obstacle detection) the along-edge semantic information to achieve precise control of the motion of the robot.

An exemplificative structure of a point cloud data processing apparatus 543 according to the embodiments of the present disclosure will be continued to describe as below. In some embodiments, as shown in FIG. 2, the software module stored in the point cloud data processing apparatus 543 of the storage 540 may include: an extraction module 5431, a first processing module 5432, a fitting module 5433, a second processing module 5434, and a combination module 5435.

The extraction module 5431 is configured to obtain a plurality of obstacle point clouds, and extract wall surface point cloud(s) from the plurality of obstacle point clouds; the first processing module 5432 is configured to obtain a first point cloud vector by projecting the obstacle point clouds in the plurality of obstacle point clouds other than the wall surface point cloud(s) to a ground surface; the fitting module 5433 is configured to project the wall surface point cloud(s) to the ground surface, and obtaining a straight line by performing a linear fitting on the projected wall surface point cloud(s); the second processing module 5434 is configured to obtain a second point cloud vector by screening the projected wall surface point cloud(s) based on the straight line; and the combination module 5435 is configured to combine the first point cloud vector and the second point cloud vector into along-edge semantic information.

In some embodiments, the extraction module 5431 may be further configured to: obtain a plurality of three-dimensional point cloud by scanning a wall using a depth camera; and select the three-dimensional point clouds with a height larger than a height threshold from the plurality of three-dimensional point cloud to use as the plurality of obstacle point clouds.

In some embodiments, the extraction module 5431 may be further configured to: determine, based on a relative positional relationship between an edge of the wall and the robot, an along-edge strategy for a robot; select the three-dimensional point clouds with the height larger than the height threshold and located on the right side of the depth camera to use as the plurality of obstacle point clouds in response to the along-edge strategy being along right edge; and select the three-dimensional point clouds with the height larger than the height threshold and located on the left side of the depth camera to use as the plurality of obstacle point clouds in response to the along-edge strategy being along left edge.

In some embodiments, the point cloud data processing apparatus 543 may further include a third processing module 5436 configured to: rescan the wall using the depth camera to obtain the three-dimensional point clouds in response to a number of the plurality of obstacle point clouds being less than a quantity threshold; and extract the obstacle point clouds from the three-dimensional point clouds obtained by rescanning the wall.

In some embodiments, the extraction module 5431 may be further configured to: obtain a plane by performing a plane fitting on the plurality of obstacle point clouds; and selecting, from the plurality of obstacle point clouds, the obstacle point clouds with a distance smaller than a first distance threshold from the plane to use as the wall surface point cloud(s).

In some embodiments, for the obstacle point clouds in the plurality of obstacle point clouds other than the wall surface point cloud(s), the first processing module 5432 may be further configured to: determine a distance between each of the obstacle point clouds and the ground surface; determine, based on the distance and a normal vector of the ground surface, a projection point of each of the obstacle point clouds on the ground surface; and obtain a first point cloud vector by combining the projection points of the obstacle point clouds.

In some embodiments, the second processing module 5434 may be further configured to: select, from the projected wall surface point cloud(s), the wall surface point cloud(s) with a distance smaller than a second distance threshold value from the straight line to use as wall line point cloud(s); and generate a second point cloud vector based on the wall line point cloud(s).

In some embodiments, the second processing module 5434 may be further configured to: identify outlier point cloud(s) from the wall line point cloud(s); and delete the outlier point cloud(s) from the wall line point cloud(s) to obtain remained wall line point clouds, and combine the remained wall line point cloud(s) into a second point cloud vector.

It should be noted that in this embodiment, the principle of the apparatus is similar to that of the method embodiment, and has similar beneficial effects as the method embodiment, hence will not be described herein. The technical details not exhaustive in the point cloud data processing apparatus may be understood based on the description of any of FIG. 3, FIG. 4, or FIG. 5.

The embodiments of the present disclosure further provide a computer program product that includes computer program or computer-executable instructions stored in a computer-readable storage medium. A processor of an electronic device reads the computer-executable instructions from the computer-readable storage medium and executes the computer-executable instructions so that the electronic device performs the above-mentioned point cloud data processing method.

The embodiments of the present disclosure further provide a computer-readable storage medium storing computer-executable instructions or computer program. The above-mentioned point cloud data processing method (e.g., the point cloud data processing method shown in FIG. 3, FIG. 4, or FIG. 5) is executed by a processor when the processor executes the computer-executable instructions or the computer program.

In some embodiments, the computer-readable storage medium may be a storage such as FRAM (Ferroelectric Random Access Memory), ROM, PROM (Programmable read-only Memory), EPROM (Erasable Programmable Read-Only Memory), EEPROM (Electrically Erasable Programmable read only memory), flash memory, magnetic surface memory, optical disk, or CD-ROM, and may also be various equipment including one of the forgoing storages or any combination of them.

In some embodiments, the computer-executable instructions may be implemented in the form of a program, software, software module, script or codes in any form of programming language (including compiled or interpreted languages, or declarative or procedural languages), and may be deployed in any form, including being deployed as a standalone program, a module, a component, a subroutine, or other unit suitable for use in a computing environment.

As an example, the computer-executable instructions may, but do not necessarily correspond to a file in the file system, and may be stored in a part of the file storing other programs or data, for example, in one or more scripts of a Hyper Text Markup Language (HTML) document, or stored in a single file dedicated to the program in question, or a plurality of collaborative files (e.g., files that store one or more modules, subroutines, or code parts).

As an example, the computer-executable instructions may be deployed to execute on one electronic device, or on a plurality of electronic devices located at one location, or a plurality of electronic devices distributed across multiple locations and interconnected over a communication network.

To sum up, through the embodiments of present disclosure, the problem of the obtained along-edge semantic not being straight in the existing related technologies can be solved effectively, and more comprehensive along-edge semantic information can be obtained so that the planning and control algorithm can be executed in a smoother way when using the along-edge semantic information obtained in the embodiments of present disclosure. At the same time, since the along-edge semantic information retains the obstacle point cloud information, the robot will consider whether there are obstacles in the path when performing along-edge motions based on the along-edge semantic information, that is, it can make the robot to have better obstacle avoidance ability and effectively avoid collisions with the obstacles of different heights during along-edge motions.

The foregoing are only the embodiments of the present disclosure and are not intended to limit the scope of the protection of the present disclosure. Any modification, equivalent substitution, improvement, and the like made within the spirit and scope of the present disclosure are included within the scope of the protection of the present disclosure.

What is claimed is:

1. A method for processing point cloud data including a plurality of obstacle point clouds, comprising:
obtaining the plurality of obstacle point clouds, and extracting one or more wall surface point clouds from the plurality of obstacle point clouds;
obtaining a first point cloud vector by projecting the obstacle point clouds in the plurality of obstacle point clouds except the one or more wall surface point clouds to a ground surface;
projecting the one or more wall surface point clouds to the ground surface, and obtaining a straight line by performing a linear fitting on the projected one or more wall surface point clouds;
obtaining a second point cloud vector by screening the projected one or more wall surface point clouds based on the straight line; and
combining the first point cloud vector and the second point cloud vector into along-edge semantic information of the point cloud data.

2. The method of claim 1, wherein extracting the one or more wall surface point clouds from the plurality of obstacle point clouds comprises:
obtaining a plane by performing a plane fitting on the plurality of obstacle point clouds; and
selecting, from the plurality of obstacle point clouds, the obstacle point clouds with a distance smaller than a first distance threshold from the plane to use as the one or more wall surface point clouds.

3. The method of claim 1, wherein obtaining the first point cloud vector by projecting the obstacle point clouds in the plurality of obstacle point clouds except the one or more wall surface point clouds to the ground surface comprises:
for the obstacle point clouds in the plurality of obstacle point clouds except the one or more wall surface point clouds:
determining a distance between each of the obstacle point clouds and the ground surface;
determining, based on the distance and a normal vector of the ground surface, a projection point of each of the obstacle point clouds on the ground surface; and
obtaining a first point cloud vector by combining the projection points of the obstacle point clouds.

4. The method of claim 1, wherein obtaining the second point cloud vector by screening the projected one or more wall surface point clouds based on the straight line comprises:
selecting, from the projected one or more wall surface point clouds, the one or more wall surface point clouds with a distance smaller than a second distance threshold value from the straight line to use as one or more wall line point clouds; and
generating a second point cloud vector based on the one or more wall line point clouds.

5. The method of claim 4, wherein generating the second point cloud vector based on the one or more wall line point clouds comprises:
identifying one or more outlier point clouds from the one or more wall line point clouds; and
deleting the one or more outlier point clouds from the one or more wall line point clouds to obtain remained wall line point clouds, and combining the remained one or more wall line point clouds into a second point cloud vector.

6. The method of claim 1, wherein obtaining the plurality of obstacle point clouds comprises:
obtaining a plurality of three-dimensional point cloud by scanning a wall using a depth camera; and
selecting the three-dimensional point clouds with a height larger than a height threshold from the plurality of three-dimensional point cloud to use as the plurality of obstacle point clouds.

7. The method of claim 6, wherein selecting the three-dimensional point clouds with the height larger than the height threshold from the plurality of three-dimensional point cloud to use as the plurality of obstacle point clouds comprises:
determining, based on a relative positional relationship between an edge of the wall and the robot, an along-edge strategy for a robot;
selecting the three-dimensional point clouds with the height larger than the height threshold and located on the right side of the depth camera to use as the plurality of obstacle point clouds in response to the along-edge strategy being along right edge; and
selecting the three-dimensional point clouds with the height larger than the height threshold and located on the left side of the depth camera to use as the plurality of obstacle point clouds in response to the along-edge strategy being along left edge.

8. The method of claim 6, further comprising:
rescanning the wall using the depth camera to obtain the three-dimensional point clouds in response to a number of the plurality of obstacle point clouds being less than a quantity threshold; and
extracting the obstacle point clouds from the three-dimensional point clouds obtained by rescanning the wall.

9. An electronic device for processing point cloud data including a plurality of obstacle point clouds, comprising:
a processor;
a memory coupled to the processor; and
one or more computer programs stored in the memory and executable on the processor;
wherein, the one or more computer programs comprise:
instructions for obtaining the plurality of obstacle point clouds, and extracting one or more wall surface point clouds from the plurality of obstacle point clouds;
instructions for obtaining a first point cloud vector by projecting the obstacle point clouds in the plurality of obstacle point clouds except the one or more wall surface point clouds to a ground surface;
instructions for projecting the one or more wall surface point clouds to the ground surface, and obtaining a straight line by performing a linear fitting on the projected one or more wall surface point clouds;
instructions for obtaining a second point cloud vector by screening the projected one or more wall surface point clouds based on the straight line; and
instructions for combining the first point cloud vector and the second point cloud vector into along-edge semantic information of the point cloud data.

10. The electronic device of claim 9, wherein the instructions for extracting the one or more wall surface point clouds from the plurality of obstacle point clouds comprise:
instructions for obtaining a plane by performing a plane fitting on the plurality of obstacle point clouds; and
instructions for selecting, from the plurality of obstacle point clouds, the obstacle point clouds with a distance smaller than a first distance threshold from the plane to use as the one or more wall surface point clouds.

11. The electronic device of claim 9, wherein the instructions for obtaining the first point cloud vector by projecting the obstacle point clouds in the plurality of obstacle point clouds except the one or more wall surface point clouds to the ground surface comprise:
instructions for, for the obstacle point clouds in the plurality of obstacle point clouds except the one or more wall surface point clouds:
determining a distance between each of the obstacle point clouds and the ground surface;
determining, based on the distance and a normal vector of the ground surface, a projection point of each of the obstacle point clouds on the ground surface; and
obtaining a first point cloud vector by combining the projection points of the obstacle point clouds.

12. The electronic device of claim 9, wherein instructions for obtaining the second point cloud vector by screening the projected one or more wall surface point clouds based on the straight line comprise:
instructions for selecting, from the projected one or more wall surface point clouds, the one or more wall surface point clouds with a distance smaller than a second distance threshold value from the straight line to use as one or more wall line point clouds; and
instructions for generating a second point cloud vector based on the one or more wall line point clouds.

13. The electronic device of claim 12, wherein the instructions for generating the second point cloud vector based on the one or more wall line point clouds comprise:
instructions for identifying one or more outlier point clouds from the one or more wall line point clouds; and
instructions for deleting the one or more outlier point clouds from the one or more wall line point clouds to obtain remained wall line point clouds, and combining the remained one or more wall line point clouds into a second point cloud vector.

14. The electronic device of any of claim 9, wherein the instructions for obtaining the plurality of obstacle point clouds comprise:
instructions for obtaining a plurality of three-dimensional point cloud by scanning a wall using a depth camera of the electronic device; and
instructions for selecting the three-dimensional point clouds with a height larger than a height threshold from the plurality of three-dimensional point cloud to use as the plurality of obstacle point clouds.

15. The electronic device of claim 14, wherein the instructions for selecting the three-dimensional point clouds with the height larger than the height threshold from the plurality of three-dimensional point cloud to use as the plurality of obstacle point clouds comprise:
instructions for determining, based on a relative positional relationship between an edge of the wall and the robot, an along-edge strategy for a robot;
instructions for selecting the three-dimensional point clouds with the height larger than the height threshold and located on the right side of the depth camera to use as the plurality of obstacle point clouds in response to the along-edge strategy being along right edge; and
instructions for selecting the three-dimensional point clouds with the height larger than the height threshold and located on the left side of the depth camera to use as the plurality of obstacle point clouds in response to the along-edge strategy being along left edge.

16. The electronic device of claim 14, the one or more computer programs further comprise:
instructions for rescanning the wall using the depth camera to obtain the three-dimensional point clouds in response to a number of the plurality of obstacle point clouds being less than a quantity threshold; and
instructions for extracting the obstacle point clouds from the three-dimensional point clouds obtained by rescanning the wall.

17. A non-transitory computer-readable storage medium for storing one or more computer programs, wherein the one or more computer programs comprise:
instructions for obtaining a plurality of obstacle point clouds included in point cloud data, and extracting one or more wall surface point clouds from the plurality of obstacle point clouds;
instructions for obtaining a first point cloud vector by projecting the obstacle point clouds in the plurality of obstacle point clouds except the one or more wall surface point clouds to a ground surface;
instructions for projecting the one or more wall surface point clouds to the ground surface, and obtaining a straight line by performing a linear fitting on the projected one or more wall surface point clouds;
instructions for obtaining a second point cloud vector by screening the projected one or more wall surface point clouds based on the straight line; and
instructions for combining the first point cloud vector and the second point cloud vector into along-edge semantic information of the point cloud data.

18. The storage medium of claim 17, wherein the instructions for extracting the one or more wall surface point clouds from the plurality of obstacle point clouds comprise:
instructions for obtaining a plane by performing a plane fitting on the plurality of obstacle point clouds; and
instructions for selecting, from the plurality of obstacle point clouds, the obstacle point clouds with a distance smaller than a first distance threshold from the plane to use as the one or more wall surface point clouds.

19. The storage medium of claim 17, wherein the instructions for obtaining the first point cloud vector by projecting the obstacle point clouds in the plurality of obstacle point clouds except the one or more wall surface point clouds to the ground surface comprise:
instructions for, for the obstacle point clouds in the plurality of obstacle point clouds except the one or more wall surface point clouds:
determining a distance between each of the obstacle point clouds and the ground surface;
determining, based on the distance and a normal vector of the ground surface, a projection point of each of the obstacle point clouds on the ground surface; and
obtaining a first point cloud vector by combining the projection points of the obstacle point clouds.

20. The storage medium of claim 17, wherein the instructions for obtaining the second point cloud vector by screening the projected one or more wall surface point clouds based on the straight line comprise:
instructions for selecting, from the projected one or more wall surface point clouds, the one or more wall surface point clouds with a distance smaller than a second distance threshold value from the straight line to use as one or more wall line point clouds; and
instructions for generating a second point cloud vector based on the one or more wall line point clouds.
